(19) United States
(12) Patent Application Publication
(10) Pub. No.: US 2016/0201899 A1
(43) Pub. Date: Jul. 14, 2016

(54) CANDLE CARTRIDGE

(71) Applicant: CUP CANDLE GMBH, Greven (DE)

(72) Inventors: Lydia KLEFFMANN, Hüllhorst (DE); Andrea STEINMEIER, Hüllhorst (DE); Linette INDERBIETHEN, Wohltorf (DE)

(73) Assignee: CUP CANDLE GMBH, Greven (DE)

(21) Appl. No.: 14/913,155

(22) PCT Filed: Aug. 21, 2014
(86) PCT No.: PCT/EP2014/067823

§ 371 Date: Feb. 19, 2016

Related U.S. Application Data
(63) Continuation of application No. 14/227,513, filed on Mar. 27, 2014.

(30) Foreign Application Priority Data
Aug. 22, 2013 (DE) 10 2013 216 702.4
Sep. 10, 2013 (DE) 10 2013 218 067.5
Nov. 13, 2013 (DE) 10 2013 223 078.8
Mar. 28, 2014 (CN) 201410121348.6
Apr. 14, 2014 (DE) 10 2014 207 111.9
Jun. 6, 2014 (DE) 10 2014 210 888.8

(51) Int. Cl. F23D 3/16; B29C 43/18; B29C 43/00; B29C 43/02; C11C 5/00; C11C 5/02

(52) U.S. Cl. CPC F23D 3/16; C11C 5/008; C11C 5/023; B29C 43/003; B29C 43/021; B29C 43/18; B29K 2001/00

(57) ABSTRACT

A candle magazine has a multiplicity of deep-drawn cup-like structures in which there is provided in each case one candle composed of a combustible material and of a wick. A candle, method for producing a candle or a candle magazine, and a deep-drawing apparatus are also provided.

The present invention relates to a candle magazine which has a multiplicity of deep-drawn cup-like structures in which there is provided in each case one candle composed of a combustible material and of a wick. The present invention also relates to a candle, to a method for producing a candle or a candle magazine, and to a deep-drawing apparatus.

At present, candles, in particular tealights, are provided in an aluminum container. The production of said candles is however highly cumbersome and a large amount of packaging waste, which places a burden on the environment, is produced.

It was therefore the object of the present invention to provide a candle magazine or a candle that does not have the disadvantages of the prior art.

The object is achieved by means of a candle magazine which has a multiplicity of deep-drawn cup-like structures in which there is provided in each case one candle composed of a combustible material and of a wick.

The statements made regarding this subject of the present invention apply equally to the other subjects of the present invention and vice versa.

The present invention relates to a candle magazine which has a multiplicity of deep-drawn cup-like structures. For this purpose, a planar material web is generally provided which is subsequently deep-drawn under the influence of an elevated temperature and/or pressure and/or vacuum such that the cup-like structure is formed in the material web. A candle is then provided in said cup-like structure, which candle is composed of a combustible material, in particular wax, for example beeswax, stearin and/or paraffin, that is to say in particular hardened or refined vegetable and/or animal fats, wax-like materials and/or technical wax mixtures, and of a wick. The combustible material is initially solid and is at least partially liquefied as a result of the release of heat from the burning wick.

In this way, it is advantageously possible, in a simple manner, to produce candle magazines and/or candles which are easy to produce, stack and therefore also transport. In relation to conventional tealights in aluminum containers, the candle magazine according to the invention can be produced more quickly and with lower production costs. Furthermore, owing to the lower thermal conductivity of the material from which the magazine is produced in relation to aluminum, less energy is released to the cup-like structure by heat conduction, and the burn-off of the candle is thus advantageously slowed. In this way, less combustible material is required to achieve the same combustion duration. Furthermore, the candle magazine according to the invention advantageously does not heat up to the same extent as a conventional candle container composed of aluminum or glass. If the candle is arranged in a vessel, for example for decorative purposes, then the risk of ignition of the candle as a whole, or of the magazine, such as exists in the case of candles with an aluminum casing, is advantageously eliminated. A further advantage of the candle magazine according to the invention consists in that there is no risk, or at least a greatly reduced risk, of a user being burned, because the material from which the magazine is produced does not reach temperatures as high as those encountered during the burn-off of the candles in the case of the vessels known from the prior art.

The combustible material preferably has no colorants whatsoever. The combustible material particularly preferably has at least one colorant, in particular such that the combustible material in the cup-like structure is at least partially transparent. The combustible material very particularly preferably has the same colorant as the material from which the cup-like structure is manufactured. The combustible material is even more preferably arranged in layered fashion, wherein at least two layers have a different colorant. The combustible material preferably comprises one or more scents. The combustible material preferably comprises an additive which has the effect of coloring the flame. In this way, it is advantageously possible to provide a white or colored candle, in particular a candle which is colored even in the lit state, that is to say has a colored flame. If the material from which the cup-like structure or the material is manufactured is also colored, an aesthetically pleasing overall color impression is realized.

The cross section of the cup-like structure is preferably provided such that the length of the wick that protrudes out of the combustible material is always shorter than the shortest dimension of the cross section of the cup-like structure. This prevents the wick or the flame of the wick from coming into contact with a side wall of the cup-like structure.

Any deep-drawable material that is familiar to a person skilled in the art may be used as a material for producing the cup-like structure or the magazine. The material from which the cup-like structure or the magazine is produced is preferably a plastic, and the material web is preferably a plastics foil. The material from which the cup-like structure or the magazine is produced may be provided in single-layer or multi-layer form. The material from which the cup-like structure or the magazine is produced may be composed partially or entirely of paper, in particular deep-drawable paper, and/or from cardboard, in particular deep-drawable cardboard. The material from which the cup-like structure or the magazine is produced may be composed partially, for example in one layer, of metal, in particular aluminum. The material from which the cup-like structure or the magazine is produced is preferably non-combustible and/or of low flammability. The material from which the cup-like structure or the magazine is produced particularly preferably complies with a fire protection rating in accordance with the standard UL94 V0, V1 or V2 and/or in accordance with the standards IEC/DIN EN 60 695-11-10 and/or IEC DIN EN 60 695-11-20. In this way, it is particularly advantageously possible for the cup-like structure to be manufactured from a material which, even in the event of improper use, does not burn and conducts heat only poorly, which firstly lowers the fire risk in relation to cup-like structures composed of aluminum and secondly advantageously increases user convenience, because a candle of said type can, even in a lit state, be comfortably held by a user, without the risk of the user being burned.

The material from which the cup-like structure and/or the magazine is produced is preferably REACH-compliant. This means that the material complies with the requirements of the directive (EC) no. 1907/2006 (REACH).

Examples of such materials are:
technical polymers
wood/plastic composite materials
bioplastics
thermoplastic starches
crystalline polyethylene terephthalate (C-PET)
amorphous polyethylene terephthalate (A-PET)
polyethylene terephtalate with glycol (PET-G)
polyether ether ketone (PEEK)
polytetrafluoroethylene (PTFE)
polyamide imide (PAI)
polyvinylidene fluoride (PVDF)
ethylene vinyl acetate (EVA)
polycarbonate (PC)
polyvinyl chloride (PVC)
Terratec
Biocellat
maize starch
paper of low flammability or composite foils of low flammability, and/or
composite materials composed of plastics and biomaterial.

A person skilled in the art understands that, in particular, all thermoformable foils with cellulose may be used.

The bioplastic is preferably a polyactide (PLA), a cellulose product, a starch product, composed in particular of potato starch and/or maize starch, and/or polyhydroxybutyrate (PHB).

The plastics foil is preferably a PET foil, in particular an A-PET foil or a PET-G foil, a PC foil, a PLA foil and/or an EVA foil. The material web is particularly preferably a composite foil, in particular a PET-GAG foil. A PET-GAG foil of said type has multiple layers, very particularly preferably a layer of an A-PET foil, which is connected on both sides to in each case one layer of PET-G foil. Even more preferably, the A-PET foil layer has a thickness of 80% of the total thickness of the PET-GAG foil, and in particular, the PET-G foil layers have a thickness of an each case 10% of the total thickness of the PET-GAG foil. A PET-GAG foil of said type offers the advantage that the surface is easily printable, sealable and weldable and also food-safe. The A-PET foil layer yields a certain strength, limits the gas permeability, and is cheaper than a PET-G foil of the same thickness. Furthermore, a recycled A-PET foil may also be used, such that the sustainability of the foil is advantageously increased.

A person skilled in the art understands that plastics composite materials refer in particular to plastics to which an additive has been added. The additive is preferably provided such that the plastics composite that is formed has a higher fire protection rating than the plastic without additive.

The foil thickness is preferably between 0.00001 mm and 2 mm, particularly preferably between 2 μm and 7 μm, very particularly preferably between 3 μm and 4 μm.

The material from which the cup-like structure or the magazine is produced may be transparent and/or colored. The material may be printed using any desired method familiar to a person skilled in the art. In particular, the material may be transparent and printed with color. This advantageously makes it possible to provide a substantially transparent cup-like structure or a substantially transparent magazine and nevertheless provide important product information and/or warnings on the cup-like structures. Furthermore, in the case of an at least partially colored material, it is advantageously possible for a pleasing appearance of the magazine to be realized. For scented candles in particular, it is thus possible to realize simple color coding. For example, red candle magazines, that is to say candle magazines produced from an at least partially red material, may have a rose scent, green candle magazines may have an apple scent, and white or colorless candle magazines may be substantially scentless.

In a preferred embodiment, the combustible material at least partially has the same color as the material from which the cup-like structure and/or the magazine is produced. In this way, it is advantageously possible to provide a uniform appearance of the candle magazine and/or of the individual candles. A person skilled in the art understands that, alternatively or in addition, the combustible material may at least partially have a different color than the material from which the cup-like structure and/or the magazine is produced. In this way, it is possible in a particularly advantageous manner to realize different color effects, in particular in a burning candle. For example, a candle with a red cup-like structure but a green combustible material appears yellow at least in the lit state.

It is particularly preferable for the material from which the cup-like structure or the magazine is produced to at least partially have a compostible material, in particular a natural raw material, which has starch, for example. In this way, the cup-like structure can be disposed of without residue after the candle has been burned.

The material from which the cup-like structure and/or the magazine is produced is very particularly preferably an at least partially recyclable material. In this way, the sustainability of the candle magazine according to the invention, in particular in relation to conventional candles with a cup-like structure composed of aluminum, is advantageously increased.

In one preferred embodiment, the wick is a filiform mesh. The wick particularly preferably has, in particular on its outer side, a stiffening means, for example a hard wax coating and/or a sleeve, in particular composed of a combustible material. In this way, it is advantageously possible for the wick to have a certain degree of inherent stability, and/or for the combustion characteristics of said wick to be influenced in a desired way.

In a preferred embodiment, the wick of the candle is directly or indirectly connected to the cup-like structure in positively locking, non-positively locking and/or cohesive fashion. For example, the wick has a wick holder which is preferably connected to the cup-like structure by means of adhesive bonding, sealing, welding or preferably by means of a snap-action fastener. It is however also conceivable for the wick to be connected to the cup-like structure in positively locking, non-positively locking and/or cohesive fashion without a wick holder, for example by pressing-in and/or sealing. It is particularly preferable for the wick, the wick holder and/or the cup-like structure to be connected by way of ultrasound sealing and/or by way of an in particular fire-retardant adhesive, in particular a melt adhesive (hot melt).

In one preferred embodiment of the present invention, each cup-like structure has a base region in which there is provided a recess and/or protuberance and/or an opening in which the wick and/or a wick holder is fastened. Said fastening is particularly preferably a positively locking, non-positively locking and/or cohesive fastening. The recess or protuberance serves to prevent a slippage of the wick during the production of the candle magazine and/or as the candle is burned. The recess and/or protuberance preferably has an undercut that interacts in positively locking and/or non-positively locking fashion with the wick and/or with the wick holder.

It is furthermore preferable for the base region to be provided so as to be inclined relative to the horizontal at least in sections. It is ensured in this way that the combustible material that liquefies as the candle is burned flows in the direction of the wick such that at least the most complete possible burn-off of the combustible material is ensured.

In a preferred embodiment, the side wall is provided so as to be inclined relative to the vertical at least in sections. The cup-like structure particularly preferably has a substantially conical shape, wherein in particular, the diameter in the base region is smaller than the diameter in the region of an opening, situated opposite the base region, of the cup-like structure. In this way, firstly, a controlled and complete burn-off of the combustible material is ensured, and secondly, it is ensured in a particularly advantageous manner that the candle fits into vessels of different fit, that is to say different diameter. The candle can thus advantageously be used in a flexible manner. Furthermore, a cup-like structure of said type can be more easily demolded.

It is preferable for a predetermined breaking point to be provided between at least two cup-like structures of the magazine such that the individual cup-like structures can be easily separated off by a user and made available as individual candles. The predetermined breaking point is particularly preferably rectilinear, such that the separated cup-like structures have, in at least one horizontal plane, a substantially rectangular, in particular square, cross-sectional area. In this way, it is advantageously possible, with corresponding arrangement of the predetermined breaking points, that, after the separation of the cup-like structures, no waste material of the material web is generated or, with corresponding dimensioning of the predetermined breaking points, only a small amount of, in particular grid-shaped, waste material of the material web is generated.

Alternatively, the predetermined breaking point is provided, at least in sections, along a curved line, in particular of a circle. In this way, it is advantageously ensured that the separated cup-like structures have an at least partially circular shape. The predetermined breaking point very particularly preferably has the same shape as the horizontal cross section of the cup-like structure, in particular of the interior space of the cup-like structure, wherein the predetermined breaking point preferably has a larger dimension than the cup-like structure. Even more preferably, the predetermined breaking point is provided concentrically with respect to the cup-like structure. The predetermined breaking point may be formed into the material web by punching or by way of a laser or the like. The predetermined breaking point is preferably provided after the cup-like structures have been deep-drawn, and in particular after the cup-like structures have been filled with the combustible material, the wick and/or the wick holder. It is however also possible for the predetermined breaking points to be provided in the material web before the latter is deep-drawn.

In one preferred embodiment, the cup-like structure has a means that connects the combustible material to the cup-like structure in positively locking and/or non-positively locking fashion. Said positive locking and/or non-positive locking is preferably such that it holds the candle in the cup-like structure for example during the transportation and/or use of said candle, but can be relatively easily overcome by manual force such that the candle can be removed from the cup-like structure if desired.

The user can use the candles by separating off the individual cup-like structures. It is however also possible for the user to remove the combustible material together with the wick from the cup-like structure and to burn the said candle separately from the deep-drawn cup-like structure. This embodiment is preferable in particular in the case of so-called floating candles, refill packs or refill candles.

In one preferred embodiment, the candle magazine has a connection surface to which a cover foil can be fastened, in particular by sealing. By means of this preferred embodiment of the present invention, each cup-like structure is closed off, and the candle situated therein is thereby protected. In particular in the case of so-called scented candles, a cover foil prevents an outgassing of the scent before the candle is burned, and/or, in the case of a candle magazine in which the individual candles at least partially have different scents, mixing of the scents is prevented. Furthermore, said cover foil, and also the material from which the cup-like structure or the magazine is manufactured, may be printed with information or branding or the like. The cover foil preferably has a predetermined breaking point between two cup-like structures. The cover foil preferably has, in the region of each cup-like structure, an opening region by which the cover foil can be pulled off from the cup-like structure preferably after the latter has been separated off. The opening region is particularly preferably provided as a tab. The cover foil may be printed using any desired method that is familiar to a person skilled in the art. The connecting area is preferably the encircling edge, described below, at which the cover foil is sealed. The sealing is performed in particular by way of ultrasound.

In a preferred embodiment, the cover foil is at least regionally transparent, in particular substantially completely transparent. The cover foil is particularly preferably produced from a plastics and/or aluminum foil, in particular from a foil which exhibits low flammability and/or which is non-combustible. A person skilled in the art understands that possible materials for the cover foil include in particular the materials mentioned in this application for the cup-like structure and/or magazine material. The cover foil is very particularly preferably produced from the same material as the cup-like structure and/or the magazine. Even more preferably, the cover foil is produced from a sealable and/or weldable material.

Alternatively or in addition, the candle magazine as a whole may be provided in a packaging, for example a tubular-bag-type packaging. Said packaging may likewise be printed with branding, product information or the like.

In a preferred embodiment, the candle magazine and/or a candle has an inlay means. This is in particular a colored and/or printed inlay means. The inlay means is particularly preferably arranged, in separated or separable fashion, in the region of the cup-like structure, in particular in the region of the opening situated opposite the base region. In this way, it is advantageously possible for information, warnings and/or advertisements to be provided in the individual candles. Furthermore, the candles burn more uniformly with the inlay means. In the case of advertisements, these can advantageously be clearly read from above throughout the burning duration of the candle. A person skilled in the art understands that the inlay means may be provided in separated form in the cup-like structures already before the separation of the candles, or alternatively, the inlay means is separated together with the candles.

In a preferred embodiment, the inlay means is provided in circular or polygonal form, and in particular, the outer contour of the inlay means corresponds to an inner cross section of the cup-like structure. The inlay means is particularly preferably of substantially disk-shaped or plate-shaped form. The inlay means is very particularly preferably arranged on the combustible material. Even more preferably, the inlay means is connected in positively locking, non-positively locking and/or cohesive fashion to the combustible material, in particular is adhesively bonded thereto, preferably by way of a non-combustible adhesive. In this way, it is advantageously ensured that the inlay means does not slip during the transportation and use of the candle and/or of the candle magazine.

The inlay means is preferably manufactured from a metal, in particular aluminum, a plastic, in particular a non-combustible plastic, and/or a cellulose-containing material. The inlay means is particularly preferably manufactured from a foil material. For this purpose, reference is made in particular to the materials mentioned in conjunction with the material from which the cup-like structures and/or the magazine are manufactured. In this way, the inlay means can advantageously be produced with low costs and with a low weight.

The inlay means preferably has an in particular centrally arranged opening in which the wick can be arranged, or through which the wick can be passed.

In a preferred embodiment, the inlay means is of sheetlike form and is arranged in particular on the candle magazine, for example is placed loosely on the candle magazine. The inlay means particularly preferably has a predetermined breaking point such that at least a single cup-like structure together with a separable region of the inlay means can be separated off by the user. The predetermined breaking point is particularly preferably rectilinear. Alternatively or in addition, the predetermined breaking point is provided, at least in sections, along a curved line, in particular of a circle. It is advantageously ensured in this way that the separated cup-like structures, and the separated regions of the inlay means arranged therein, have an at least partially circular shape. The predetermined breaking point very particularly preferably has the same shape as the horizontal cross section of the cup-like structure, in particular of the interior space of the cup-like structure, wherein the separable region defined by the predetermined breaking point preferably has a smaller dimension than the corresponding cross section of the cup-like structure. Even more preferably, the predetermined breaking point is provided concentrically with respect to the cup-like structure and/or with respect to a predetermined breaking point of the cup-like structures and/or of the candle magazine. The predetermined breaking point may be formed into the inlay means by punching or by way of a laser or the like.

The inlay means is preferably arranged, in particular loosely, on the candle magazine and provided together therewith in a tubular-bag-type packaging. The inlay means is particularly preferably provided in unipartite fashion or separately in the cup-like structures. The inlay means is very particularly preferably sealed onto the candle magazine.

Alternatively or in addition, the inlay means is arranged between at least one cup-like structure and a cover foil. In this way, it is particularly advantageously possible for the inlay means to be optionally provided as a replacement for a cover foil or, for example in the case of scented candles, for the candle magazine with inlay means to be sealed in aroma-tight fashion by way of a cover foil, wherein the inlay means is arranged in particular in movable fashion on the combustible material.

In a preferred embodiment, the inlay means is provided as an endless band. An endless band of said type can be produced for example by way of a labeling machine, and has a substrate material on which the inlay means is arranged, in particular adhesively bonded, in separable fashion at regular intervals.

In a preferred embodiment, each cup-like structure has an encircling edge in the upper region. The edge is particularly preferably provided substantially horizontally, in particular at an angle of approximately 90 degrees with respect to the side wall, wherein a radius of curvature is very particularly preferably provided between the edge and the side wall. Alternatively, the edge is provided so as to be inclined relative to the horizontal. The edge is very particularly preferably provided as a connecting surface. Even more preferably, the edge has an encircling embossment, in particular an elevation, such as for example a ridge. Through the provision of an edge, it is ensured that the candle can be more easily gripped by a user, in particular even when the candle is in a burning or hot state. Furthermore, the stability of the cup-like structure is advantageously greatly increased by way of an edge of said type. Here, a horizontal edge, or an edge that encloses a right angle with the side wall, is more stable than an inclined edge. An inclined edge, or an embossment, offers the advantage of a better sealing surface for the connection to the cover foil. In particular, an embossment makes it possible for a cover foil to be sealed on quickly and easily, without the sealing apparatus, for example a sonotrode, having to be aligned exactly relative to the edge during an ultrasound sealing process.

The magazines are preferably designed such that they can be stacked, in particular when no candles are situated in the cup-like structures.

The candle magazine is preferably of multi-part form. The cup-like structures are particularly preferably produced from a deep-drawn material and, after the production process, arranged in a material web, wherein the material web very particularly preferably has openings which correspond in terms of their dimensions to the cup-like structures; in particular, the openings have a diameter which corresponds to a diameter of a cup-like structure. A person skilled in the art understands that, preferably, the diameter of the opening does not correspond to the greatest diameter of a cup-like structure, such that the cup-like structures can in particular be fastened in positively locking, non-positively locking and/or cohesive fashion to an edge in the openings. The cup-like structures are particularly preferably hooked into the openings. It is very particularly preferable for a cover foil to be arranged on the multi-part candle magazine. This advantageously permits simple packaging and particularly simple transportation. Even more preferably, the openings are formed into the material web by punching. In particular, the cup-like structures and the material web are produced from different materials. For example, the material web is produced from a strong plastic with a material thickness greater than the material thickness of a deep-drawn plastics material from which the cup-like structures are produced.

In a preferred embodiment, the material web is produced from a plastics material, and the cup-like structures are produced from a material which is non-combustible and/or of low flammability and which differs from the plastics material, in particular are produced from a cellulose-containing material of low flammability. In this way, it is advantageously the case that candles are provided which can be disposed of in a particularly straightforward and environmentally friendly manner and which can be transported easily and safely by way of the material web in which they are arranged.

The present invention also relates to a candle having a combustible material and a wick, which candle is provided in a deep-drawn cup-like structure.

The statements made regarding this subject of the present invention apply equally to the other subjects of the present invention and vice versa.

The candle according to the invention is advantageously simple and inexpensive to produce. Owing to the lower thermal conductivity of the plastic relative to aluminum, less energy is released to the cup-like structure by heat conduction, and the burn-off of the candle is advantageously slowed. In this way, less combustible material is required to achieve the same combustion duration. Furthermore, the cup-like structure of the candle according to the invention advantageously does not heat up to the same extent as a conventional candle container composed of aluminum or glass. If the candle is arranged in a vessel, for example for decorative purposes, then the risk of ignition of the candle as a whole, such as exists in the case of candles with an aluminum casing, is advantageously eliminated. A further advantage of the candle according to the invention consists in that there is no risk, or at least a greatly reduced risk, of a user being burned, because the cup-like structure does not reach temperatures as high as those encountered during the burn-off of the candle in the case of the vessels known from the prior art.

The wick of the candle may be connected directly or indirectly to the packaging cup-like structure, and it is preferable for the deep-drawn cup-like structure to be directly filled with the combustible material, with the combustible material hardening in said cup-like structure.

The cup-like structure preferably has a base region and a side wall and an opening situated opposite the base region. The cup-like structure particularly preferably has a rectangular, in particular square, circular, star-shaped or polygonal horizontal cross-sectional area. It is very particularly preferable for the side wall to be inclined relative to the vertical, and/or for the base region to be inclined relative to the horizontal, in particular inclined such that the combustible material, in the liquid state, flows along the base in the direction of the wick, which is situated in the center of the base. This permits flexible use in vessels of different diameter, and furthermore, the combustible material can flow more easily in the direction of the wick along the incline, and thus an improved and as far as possible complete burn-off of the candle can be ensured.

A person skilled in the art understands that expressions such as horizontal or vertical relate to a normal orientation of a cup-like structure or candles, that is to say to a positioning of the cup-like structure or candle on a level surface. A person skilled in the art also recognizes that the orientation of the cup-like structure or candle or of the candle magazine is not restricted to such an orientation.

The cup-like structure preferably has a recess for the wick or a wick holder. In this way, it is possible in a particularly advantageous manner to realize fixing and/or stabilization of the wick, in particular positively locking and/or non-positively locking pre-fixing, before the wick is connected to the cup-like structure. Furthermore, a combustion stopper is realized in this way. Furthermore, the cup-like structure can prevent a slippage of the wick if the combustion material has at least substantially liquefied and the candle is placed in an oblique position.

The candle preferably has a wick holder, wherein the material from which the wick holder is manufactured is a plastic, metal, or a natural wax, an artificial wax, a wax-like material, and/or a technical wax mixture. In this way, it is particularly advantageously possible to use already known and tested wick holders, whereby the production costs of the candle are lowered.

The material from which the wick holder is manufactured is preferably non-combustible and/or of low flammability. The material from which the wick holder is produced particularly preferably complies with a fire protection rating in accordance with the standard UL94 V0, V1 or V2 and/or in accordance with the standards IEC/DIN EN 60 695-11-10 and/or IEC DIN EN 60 695-11-20.

It is preferable for the material from which the wick holder is manufactured to be compostable. It is very particularly preferable for the wick holder to be manufactured from the same material as the cup-like structure and/or from the same material as the combustible material. In this way, the sustainability of the candle is advantageously improved, because both the number of waste items to be separately disposed of is reduced, and/or the candle, after burning out, can be recycled and/or composted in its entirety.

The material from which the wick holder is manufactured is preferably a sealable material, in particular a plastic. Alternatively or in addition, the wick holder has, at least on the side facing toward the base region of the cup-like structure, a sealable coating, in particular a sealable plastics coating.

The wick holder is preferably provided as a combustion stopper. In this way, it is advantageously possible for the wick to burn only as far as the wick holder, with the flame then being extinguished, such that adverse impairment, in particular a risk of fire, of an underlying surface is eliminated. The wick holder particularly preferably has a flame-extinguishing impregnation, coating and/or shape.

The wick is preferably connected in positively locking, non-positively locking and/or cohesive fashion to the wick holder, in particular by being cast into, adhesively bonded into, clamped into or thermally and/or mechanically connected to the wick holder. A mechanical connection will be understood by a person skilled in the art to mean in particular a positively locking and/or non-positively locking connection. A thermal connection is a cohesive connection, for example by sealing or welding. The wick and/or the wick holder particularly preferably have, at least in sections, a sealable coating and/or a positive locking and/or non-positive locking means.

According to a preferred embodiment, the wick is provided in the form of an endless band, wherein it is particularly preferable for wick holders to be provided, in particular integrally formed, on the endless band in particular at regular intervals.

In a preferred embodiment, the candle has a stabilization means. The stabilization means is particularly preferably at least one embossment of the side wall, in particular a recess and/or protuberance which runs around the entire circumference of the side wall. Alternatively or in addition, the stabilization means is at least one embossment in a transition region between the base region and the side wall. The stabilization means is preferably provided as a bead or double bead, in particular in the region mentioned above. In this way, it is advantageously possible for thermal spring-back or restoring of the material from which the cup-like structure is manufactured to be at least reduced, for example when the transition region is warmed up during the burning of the candle.

In a preferred embodiment, the cup-like structure has, on its underside, at least one rest surface, in particular a foot, by which the candle is supported on an underlying surface. The rest surface is particularly preferably produced in one piece with the base region, that is to say is likewise manufactured by deep drawing. The foot is very particularly preferably a concentric embossment which is of encircling form at least in sections. Alternatively or in addition, the foot is a local, in particular hemispherical or cuboidal, embossment. In this way, a rest surface is provided which advantageously allows the candle to stand in a stable manner, which increases the operational safety of the candle. Furthermore, air recirculation around the underside of the cup-like structure is made possible, whereby a build-up of heat is prevented, and the burn-off of the candle is more controlled and slower. Damage to the surface on which the candle is set down is also prevented.

The candle is preferably separated off from the candle magazine according to the invention.

The present invention also relates to a candle, in particular according to the present invention, having a combustible material, wherein the candle comprises, for a burning duration of 4 h, less than 12 g, preferably less than 11 g, particularly preferably less than 10 g, in particular between 8.5 g and 9.5 g, of a combustible material.

The statements made regarding this subject of the present invention apply equally to the other subjects of the present invention and vice versa.

In this way, it is advantageously possible to provide a candle that has less combustible material than a conventional candle. In relation to a known candle, for example a tealight in an aluminum container, a saving of combustible material of approximately 10% can be achieved while maintaining the same burning duration. In this way, the candle according to the invention can advantageously be produced with less material usage.

In a preferred embodiment, the candle has a cup-like structure in which the combustible material is provided. The cup-like structure is particularly preferably manufactured from a plastics material, very particularly preferably from a fire-retardant, compostable and/or recyclable plastics material, in particular a plastics foil. In this way, it is achieved in a particularly advantageous manner that the packaging waste of the candle is reduced, and sustainability is improved. Owing to the lower thermal conductivity of the plastic relative to aluminum, less energy is released to the cup-like structure by heat conduction, and the burn-off of the candle is advantageously slowed. In this way, less combustible material is required to achieve the same combustion duration. Furthermore, the cup-like structure of the candle according to the invention advantageously does not heat up to the same extent as a conventional candle container composed of aluminum or glass. If the candle is arranged in a vessel, for example for decorative purposes, then the risk of ignition of the candle as a whole, such as exists in the case of candles with an aluminum casing, is advantageously eliminated. A further advantage of the candle according to the invention consists in that there is no risk, or at least a greatly reduced risk, of a user being burned, because the cup-like structure does not reach temperatures as high as those encountered during the burn-off of the candle in the case of the vessels known from the prior art.

In a preferred embodiment, the cup-like structure is manufactured from a deep-drawn plastics material.

In a preferred embodiment, the candle comprises 8.5 g, 8.6 g, 8.7 g, 8.8 g, 8.9 g, 9.0 g, 9.1 g, 9.2 g, 9.3 g, 9.4 g or 9.5 g of the combustible material.

The present invention also relates to a candle having a combustible material and a wick which are arranged in a cup-like structure, wherein the cup-like structure is produced from a material which comprises cellulose and/or which is at least partially composed of cellulose.

The statements made regarding this subject of the present invention apply equally to the other subjects of the present invention and vice versa.

In this way, in a particularly advantageous manner, particularly good recyclability of the candle is ensured.

A person skilled in the art understands that at least some cellulose materials, such as have been described for example in the context of the present invention, are not deep-drawn but are produced from a pasty compound by way of a vacuum.

The present invention also relates to a method for producing a candle according to the invention, wherein the cup-like structure is deep-drawn from a material web, in particular a plastics foil, the wick is provided in the cup-like structure, and the cup-like structure is filled with the combustible material.

The statements made regarding this subject of the present invention apply equally to the other subjects of the present invention and vice versa.

By means of the method according to the invention, it is possible for candles to be produced in a simple and inexpensive manner. Furthermore, the cup-like structure that is left over after the candle is burned is easy to dispose of.

In a preferred embodiment, the material web is pre-drawn and/or pre-stretched before the deep-drawing process. It is particularly preferable for at least one region of the material web, before and/or during the deep-drawing process, to be cooled and/or to be fixed by way of a vacuum to a deep-drawing means, for example a deep-drawing punch. In this way, it is possible in a particularly advantageous manner for the material distribution during the deep-drawing process to be controlled in targeted fashion, and thus to realize, for example, a more homogeneous material thickness of the cup-like structure. Alternatively or in addition, it is thus possible for targetedly reinforced regions to be provided in the cup-like structure. By virtue of the material web being fixed to the deep-drawing means, in particular in a central region of the cup-like structure, it is advantageously possible for structures, for example a recess, to be realized in a simple manner already during the deep-drawing process. In the same way, the production of at least one rest surface on the underside of the cup-like structure is possible by way of targeted cooling and/or fixing by way of a vacuum.

It is preferable for the wick and/or the wick holder to be connected to the cup-like structure before, during or after the deep-drawing but before the filling of the cup-like structure with the combustible material. The wick and/or the wick holder are/is preferably adhesively bonded into the cup-like structure, in particular by way of an adhesive, in particular a melt adhesive, and/or sealed into the cup-like structure, in particular by ultrasound sealing. For this purpose, the material of the wick and/or of the wick holder and/or of the cup-like structure is particularly preferably sealable.

In an alternative embodiment, the wick and/or the wick holder is cohesively connected to the material web before, during or after the deep-drawing of said material web. A cohesive connection is realized in particular by means of adhesive bonding, welding and/or sealing.

For example, the wick and/or the wick holder may be provided in the region of the punch of a deep-drawing apparatus and, during the deep-drawing process, is pushed in the direction of the material web and, in the process, is connected to said material web in non-positively locking, positively locking and/or cohesive fashion.

The wick is preferably connected to the wick holder in positively locking, non-positively locking and/or cohesive fashion before, during or after the insertion into the cup-like structure.

In a preferred embodiment, the wick holder is formed in a recess of the cup-like structure. It is particularly preferable for the material from which the wick holder is produced to be molded, in particular poured, into the recess in the base, and for the wick to be inserted into the wick holder simultaneously or subsequently. It is very particularly preferable for the wick to be fixed until the material of the wick holder has solidified.

In a preferred embodiment, an adhesive, in particular a melt adhesive, is introduced into a recess of the cup-like structure, and subsequently, the wick is inserted into said adhesive before the latter has completely solidified, and is particularly preferably fixed until the adhesive has completely solidified or hardened. Alternatively, the adhesive is introduced into the cup-like structure, and subsequently, the wick is inserted, in particular pressed, into the adhesive before the latter has completely solidified. In this way, a wick holder is advantageously formed without the need to provide a separate wick holder and/or a recess in the cup-like structure.

In one preferred embodiment, the wick holder is pressed into a recess of the cup-like structure. It is particularly preferable for the wick holder to be molded, in particular poured and/or sprayed and/or pressed, into the recess of the cup-like structure.

In a further preferred embodiment, the cup-like structure has, in the base region, an opening into which the wick and/or the wick holder is inserted in positively locking, non-positively locking and/or cohesive fashion. It is particularly preferable for the wick and/or the wick holder to be inserted from below. Alternatively, the wick and/or the wick holder is inserted into the opening from above. It is very particularly preferable for the wick and/or the wick holder to subsequently be connected in positively locking, non-positively locking and/or cohesive fashion to the opening or to the cup-like structure material adjoining the opening. In particular, the wick holder is connected to the opening, or to the material adjoining the opening, by welding, pressing, crimping, adhesive bonding and/or upsetting.

In one preferred embodiment, the wick is provided as an endless band on which wick holders are provided, in particular at regular intervals. The wick holders are particularly preferably formed on the wick. It is very particularly preferably provided that the endless band is guided through the opening of the cup-like structure from above or below, the wick holder and/or the wick is connected to the cup-like structure, and the wick is cut to length.

In one preferred embodiment, for each cup-like structure, a wick equipped with a wick holder is inserted into the cup-like structure by a wick supply means in a first step, and in a second step, said wick equipped with a wick holder is connected to the cup-like structure in positively locking and/or non-positively locking fashion, in particular by pressing and/or upsetting.

In one preferred embodiment, a molding means is filled with the material from which the wick holder is produced, a wick is arranged in the molding means and/or in the material, and the material is hardened, and the wick with the wick holder formed thereon is removed from the molding means and connected to the cup-like structure or the material web. It is particularly preferable for the material to be at least partially in a liquid or pasty state during the filling process. It is very particularly preferable for the molding means to be cooled and/or irradiated, for example by means of ultraviolet radiation, at least after the filling process and/or until the removal of the wick holder.

It is preferable for the combustible material to be in the form of a liquid or pasty medium when the cup-like structure is filled therewith, said combustible material hardening in said cup-like structure. The filling of the cup-like structures with the combustible material is preferably performed by means of one filling nozzle per cup-like structure, but particularly preferably at multiple cup-like structures simultaneously.

It is preferable for the cup-like structures to be cooled before, during and/or after the filling thereof with the combustible material, in order to accelerate the hardening of the combustible material.

In a preferred embodiment, a predetermined breaking point is formed into the material web, in particular by punching or perforation. In this way, the cup-like structures and/or candles are advantageously provided in separable form. It is particular preferable for multiple predetermined breaking points to be formed into the material web in the form of a grid and/or in circular form, wherein the predetermined breaking points are in particular provided concentrically with respect to the cup-like structure. It is very particularly preferable for the predetermined breaking points to be provided so as to have substantially the same cross section as the cup-like structures, for example in the interior space thereof, wherein said predetermined breaking points have, in particular, a larger dimension.

It is preferable for a separated or separable inlay means to be arranged in the cup-like structures and/or on the candle magazine. It is particularly preferable for a cover foil to be sealed onto the candle magazine. Alternatively or in addition, the inlay means is connected in positively locking, non-positively locking and/or cohesive fashion, in particular by sealing, to the cup-like structures and/or to the candle magazine.

The present invention also relates to a deep-drawing apparatus, having a forming station which forms cup-like structures into a material web by means of deep drawing, wherein said deep-drawing apparatus has a wick supply means that connects one wick per cup-like structure directly or indirectly to the material web or to the cup-like structure.

The statements made regarding this subject of the present invention apply equally to the other subjects of the present invention and vice versa.

By means of the deep-drawing apparatus according to the invention, it is advantageously possible to provide a simple, fast and inexpensive apparatus for producing the candle magazine according to the invention and/or the candle according to the invention.

In a preferred embodiment, the deep-drawing apparatus comprises a cooling means and/or a vacuum-generating means. The cooling means is particular preferably provided such that at least a predetermined region of the material web is at least temporarily cooled. In particular, the predetermined region of the material web is cooled before, during and/or after the deep-drawing process. It is also conceivable, for example, for a first region to be cooled before and/or during the deep-drawing process, whereas a second region, which at least partially differs from the first region, is cooled during and/or after the deep-drawing process. The vacuum-generating means is particularly preferably provided such that at least a predetermined region of the material web is connected or fixed, at least temporarily to the deep-drawing apparatus, in particular to a deep-drawing means, by way of a vacuum. In this way, the deep-drawing process can advantageously be controlled in a precise manner, wherein in particular, the thickness of the cup-like structure in different regions can be set in an exact manner, and structures can be generated in a particularly simple manner. The deep-drawing means is preferably a deep-drawing punch, wherein the vacuum-generating means is particularly preferably arranged in a central region of the deep-drawing punch.

In one preferred embodiment, the wick supply means is configured such that, by means thereof, a wick which is provided as an endless band and which is provided, in particular at regular intervals, with wick holders is led through an opening of the cup-like structure, and the wick is cut to length. For this purpose, the wick supply means particularly preferably comprises a means for cutting the wick to the respectively desired length. It is very particularly preferable for the wick to be cut to length after the connection of the wick and/or of the wick holder to the material web or to the cup-like structure.

In a preferred embodiment, the wick supply means is provided such that, by non-positive interaction of at least one section of the wick supply means and a recess in the base region of the cup-like structure, the recess is reversibly deformed, in particular flared. In this way, it is possible in a particularly advantageous manner for the equipping of the cup-like structure with a wick to be performed in a simple manner, wherein in particular, after the insertion of the wick and removal of the wick supply means, the elastic spring-back of the recess gives rise to a positively locking and/or non-positively locking connection to the wick.

In a preferred embodiment, the wick supply means has at least one wick holding apparatus for holding and/or inserting wicks. The wick holding apparatus is particularly preferably provided as a changeable tool. In this way, it is possible in an advantageous manner, through the use of more than one wick holding apparatus, to provide a continuously operating deep-drawing apparatus, whereby the productivity of the deep-drawing apparatus is increased. Furthermore, with a wick holding apparatus provided as a changeable tool, it is possible in a particularly advantageous manner to provide a flexible apparatus by means of which a multiplicity of different magazine sizes can be fitted with wicks in one working step.

The wick supply means, in particular the wick holding apparatus, preferably has a vacuum-generating means. The vacuum-generating means is particularly preferably provided for reversibly holding at least one wick.

In a preferred embodiment, the wick supply means, in particular the wick-holding apparatus, is provided for equipping a magazine with a multiplicity of wicks simultaneously. The wick holding apparatus particularly preferably has a multiplicity of wick holders for this purpose. The wick holders are very particularly preferably provided so as to be controllable independently of one another. In particular, the wick holders are at least coupled to the vacuum-generating means. A person skilled in the art understands that, here, it is preferable for in each case only one wick to be inserted into each cup-like structure. In this way, it is advantageously made possible for a candle magazine to be fitted with wicks in a single working step.

In a preferred embodiment, the deep-drawing apparatus, in particular the wick supply means, comprises at least one detection means. The detection means is particularly preferably provided for detecting correct positioning of at least one wick in a cup-like structure and/or in a wick holder. The detection means is very particularly preferably an optical, electrical, magnetic, electromagnetic, hydraulic and/or pneumatic detection means. For example, the detection means comprises a photodiode, a capacitive sensor, a resistive sensor and/or an inductive sensor. Alternatively or in addition, the detection means is part of the electronic control of the deep-drawing apparatus, in particular of the wick supply means. The detection means preferably detects a higher power consumption of the vacuum-generating means, in particular with regard to a single wick holder. Such a higher power consumption is then regarded as an absence or incorrect positioning of a wick. In this way, it is possible in a particularly advantageous manner to prevent a candle magazine being fitted with wicks in an erroneous manner. Since it is the case that, in the event of erroneous wick fitting or an absence of wick fitting even at a single cup-like structure, said cup-like structure cannot be separated out from the magazine, but rather the entire candle magazine must be discarded at a final inspection stage, it is thus advantageously possible for the reject rate of the deep-drawing apparatus to be reduced.

The wick supply means is preferably configured such that, if a fault signal is detected in conjunction with at least one wick holder, fitting of the other wicks is performed, and renewed wick fitting is particularly preferably performed by way of the wick holder. Alternatively, the wick supply means is configured such that, if a fault signal is detected, the wick holding apparatus is equipped with wicks again, in particular only at those wick holders to which the fault signal related.

In a preferred embodiment, the detection means is provided for detecting correct positioning of at least one wick before, during and/or after the wick fitting process. In this way, it is advantageously optionally possible for erroneous wick fitting to be avoided, and/or for a magazine that has been fitted with wicks in an erroneous manner, and/or a cup-like structure that has been fitted with a wick in an erroneous manner, to be detected and separated out.

In a preferred embodiment, the deep-drawing apparatus comprises a transportation means for transporting the deep-drawn cup-like structures to the wick supply means. The transportation means is particularly preferably a conveyor belt, in particular an endless belt.

In a preferred embodiment, the deep-drawing apparatus is at least assigned a cutting apparatus which is provided for separating off the candle magazines and/or the candles and/or which is provided for generating at least one contour of the material web in the region of a candle magazine and/or of a candle.

In a preferred embodiment, the wick supply means comprises a positioning means which provides wicks equipped with wick holders and, in a first step, for each cup-like structure, positions a wick with wick holder in the cup-like structure and, in a second step, connects the wick holder and/or wick to the cup-like structure in positively locking, non-positively locking and/or cohesive fashion. It is particularly preferable for the positioning means to have a centering means, in particular a centering disk, which is provided on the positioning means such that, by means of a positively locking and/or non-positively locking connection of the centering means to the cup-like structure, the wick and the wick holder are positioned at a predetermined location in each cup-like structure.

It is preferable for the positioning means to comprise two plates arranged substantially parallel to one another, which plates are at least partially movable, in particular perpendicular to their common main plane of extent, and at least one pipe element which extends through openings in the plates and which connects the two plates and in which at least one wick with wick holder is provided. It is particularly preferable for the main direction of extent of the pipe element to be arranged perpendicular to the main plane of extent of the plates, and is very particularly preferable for the diameter of the pipe element to substantially correspond to a largest diameter of the wick holder.

It is preferable for the pipe element to have, at its end facing toward the cup-like structure, a closing means which between an open position, in which a wick with wick holder can exit the pipe element past the closing means, and a closed position, in which the wick and the wick holder are held in the pipe element and in which the closing means can exert a force on a wick and/or wick holder positioned in the cup-like structure such that positive locking and/or non-positive locking is effected between the cup-like structure and the wick and/or the wick holder.

It is preferable for a spring means, in particular a spiral spring, to be arranged between the plates.

The plates are preferably coupled to the closing means such that a movement of at least one of the plates moves the closing means between the open position and the closed position. It is particularly preferable for the plates to be coupled to the pipe element such that a further movement of at least one of the plates moves the pipe element between a first position and a second position, wherein in the second position, a force is exerted on a wick and/or wick holder positioned in the cup-like structure.

In one preferred embodiment, the wick supply means and/or the deep-drawing apparatus is assigned a preparation station which comprises a holding apparatus and a forming means, wherein the holding apparatus and the forming means are configured such that the holding apparatus withdraws a wick with wick holder formed thereon from the forming means, wherein it is particularly preferable for the forming means to be filled, by means of a dosing unit, with a material from which the wick holder is produced, wherein a wick is inserted into the forming means and/or the material and the material is hardened. It is very particularly preferable for a transportation means, in particular a rotary disk, to be provided, which transportation means has a multiplicity of forming means. Alternatively or in addition, the transportation means is a linear guide, for example an endless belt, which has the multiplicity of forming means.

The transportation means is preferably driven such that, in a continuous manner, wick holders are formed onto wicks and withdrawn from at least one forming means of the transportation means. The wick holders is formed on the wicks in each case sequentially or in batches. Here, “in batches” should be understood to mean that in each case multiple wick holders are formed onto wicks simultaneously.

The wick connected to the material web directly or indirectly, preferably before the deep drawing of the foil web. The wick is connected to the cup-like structure during or after the deep-drawing process.

The deep-drawing apparatus preferably also has a means for cutting the wick to the respectively desired length.

Furthermore, the deep-drawing apparatus preferably has means for filling each cup-like structure with a liquid and/or or pasty combustible material. It is preferable for several such means to be provided, such that several cup-like structures can be filled simultaneously.

The deep-drawing apparatus preferably has a cooling apparatus by means of which the combustible material can be cooled after the respective cup-like structure has been filled therewith. Said cooling apparatus is particularly preferably the cooling means for the material web.

Yet a further subject matter of the present invention is a deep-drawing apparatus, having a forming station which forms cup-like structures into a material web by means of deep drawing, wherein said deep-drawing apparatus has a loading station which places in each case one complete candle into a cup-like structure and connects said candle to the cup-like structure if appropriate in positively locking and/or non-positively locking fashion.

The statements made regarding this subject of the present invention apply equally to the other subjects of the present invention and vice versa.

Yet a further subject matter of the present invention is an apparatus that delivers complete prefabricated magazines that have a multiplicity of cup-like structures. A wick may already be provided in each of said cup-like structures. The apparatus furthermore has a means with which a wick can be placed into each cup-like structure and/or with which each cup-like structure is filled with the combustible material. The prefabricated magazine may already have the predetermined breaking points for separating-off purposes. The apparatus may also have a loading apparatus with which complete candles are placed into the cup-like structures.

The statements made regarding this subject of the present invention apply equally to the other subjects of the present invention and vice versa.

It is preferable for the magazines to be delivered in stacked form. In one preferred embodiment, the apparatus therefore has a separation apparatus that separates the magazines.

The apparatus preferably comprises a sealing apparatus, in particular a so-called tray sealer, for sealing the cover foil onto the candle magazines. Tray sealers are used for sealing foodstuffs into tray-like containers. Through the use of tray sealers, simple and rapid sealing of the candle magazines to the cover foil is made possible.

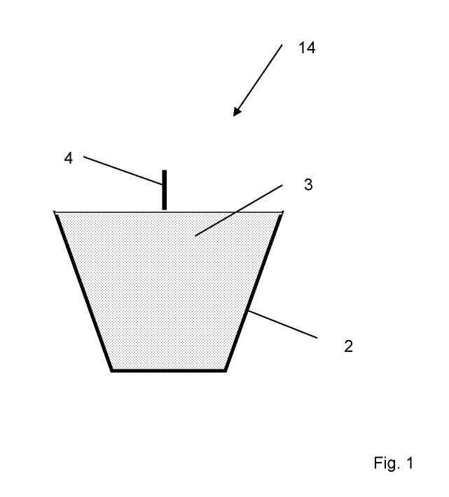

The inventions will be explained below on the basis of FIGS. 1 to 20.

These explanations are merely exemplary and do not restrict the general concept of the invention. The explanations apply equally to all subjects of the present invention.

FIG. 1 shows the candle according to the invention.

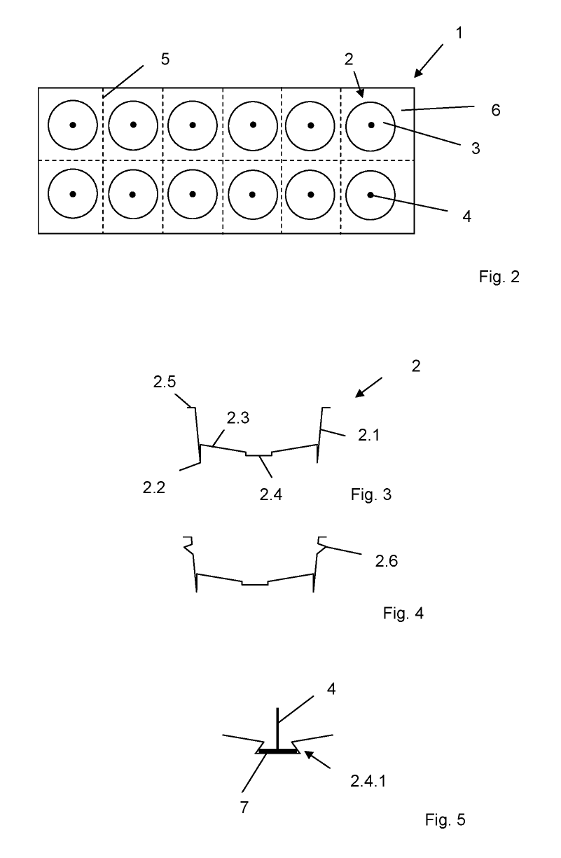

FIG. 2 shows the candle magazine according to the invention.

FIGS. 3 and 4 show exemplary embodiments of the cup-like structure.

FIG. 5 shows a recess for the wick or the wick holder.

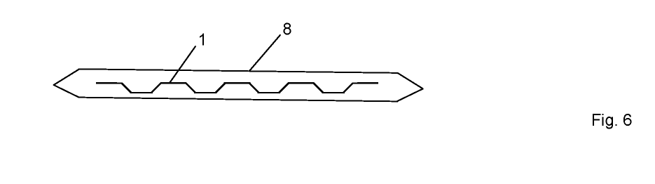

FIG. 6 shows the candle magazine in a tubular-bag-type packaging.

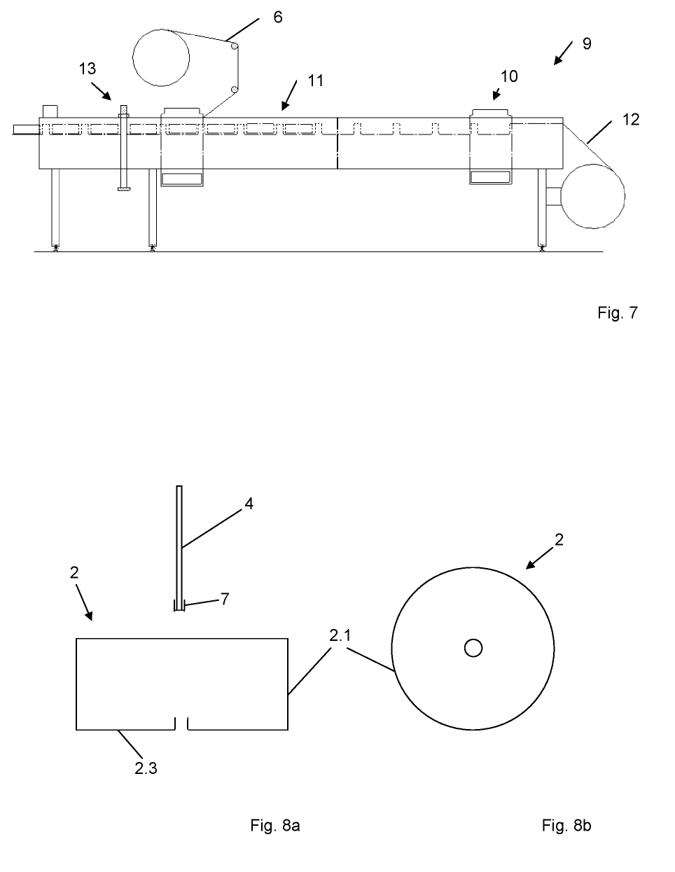

FIG. 7 shows the packaging machine according to the invention.

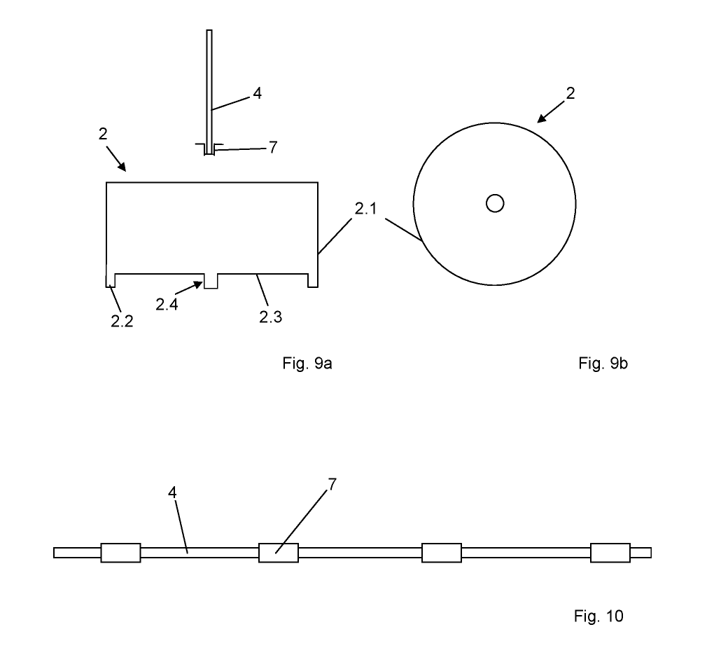

FIGS. 8a, 8b and 9a, 9b show exemplary embodiments of the cup-like structure and of the wick or wick holder.

FIG. 10 shows an embodiment of the wick and of the wick holder.

FIG. 11 shows an embodiment of the preparation station.

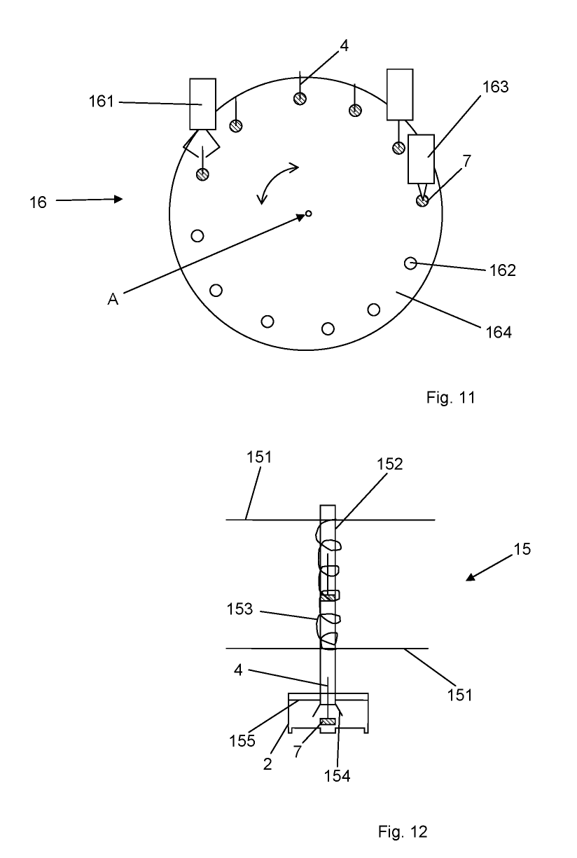

FIG. 12 shows an embodiment of the positioning means.

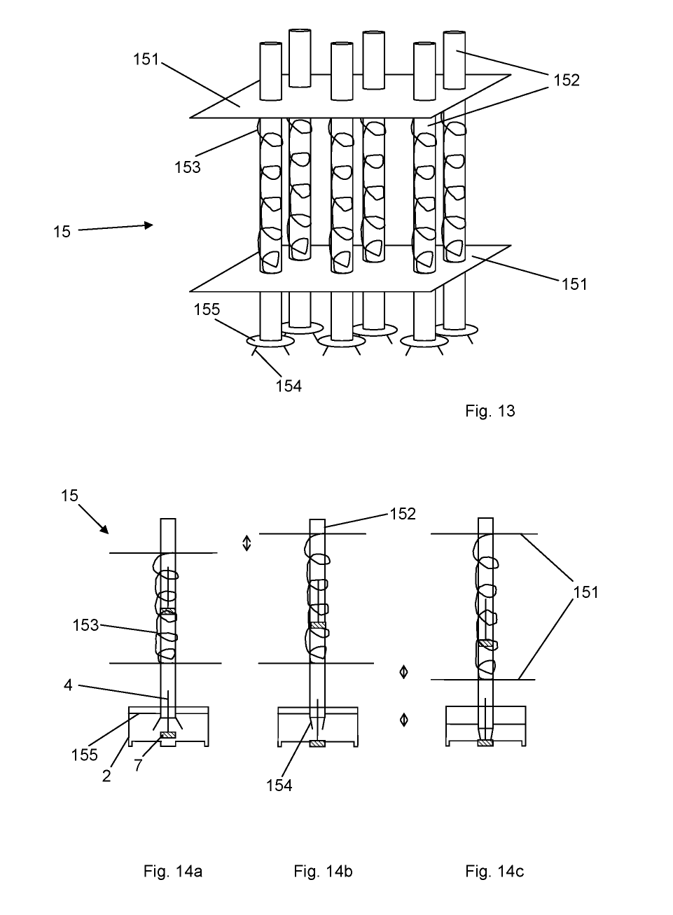

FIG. 13 shows a perspective view of the positioning means.

FIGS. 14a, 14b, 14c show the positioning means in different positions.

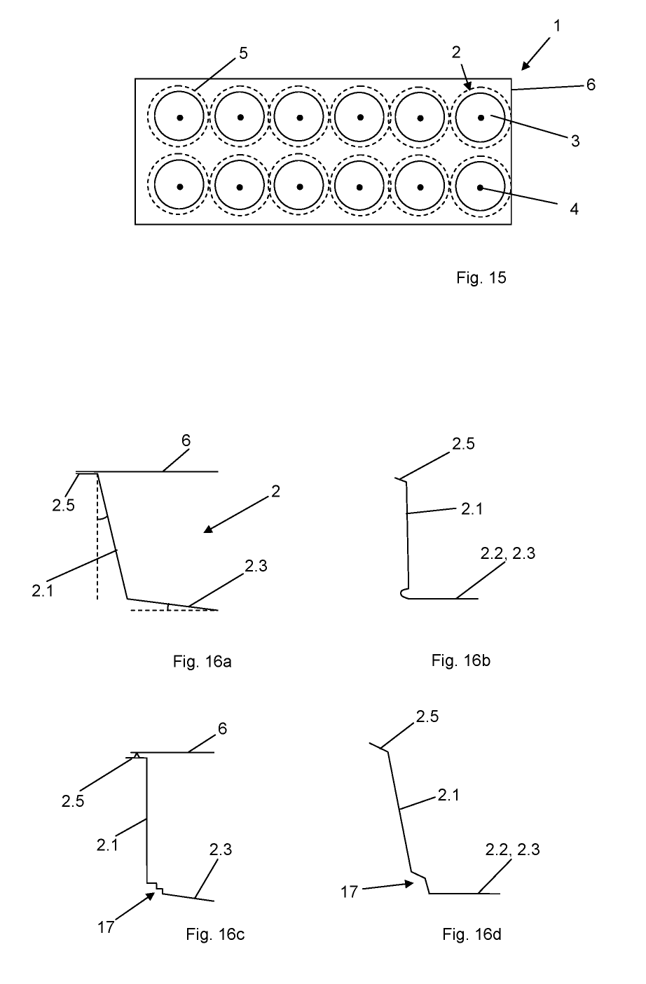

FIG. 15 shows a candle magazine according to the invention.

FIGS. 16a to 16d show different embodiments of the cup-like structure.

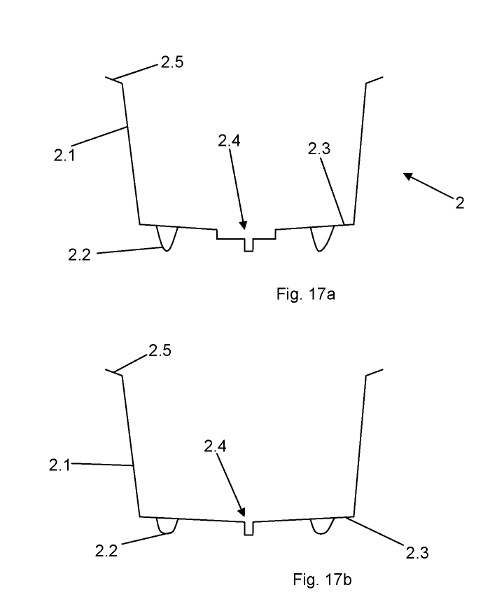

FIGS. 17a and 17b show recesses for the wick or the wick holder.

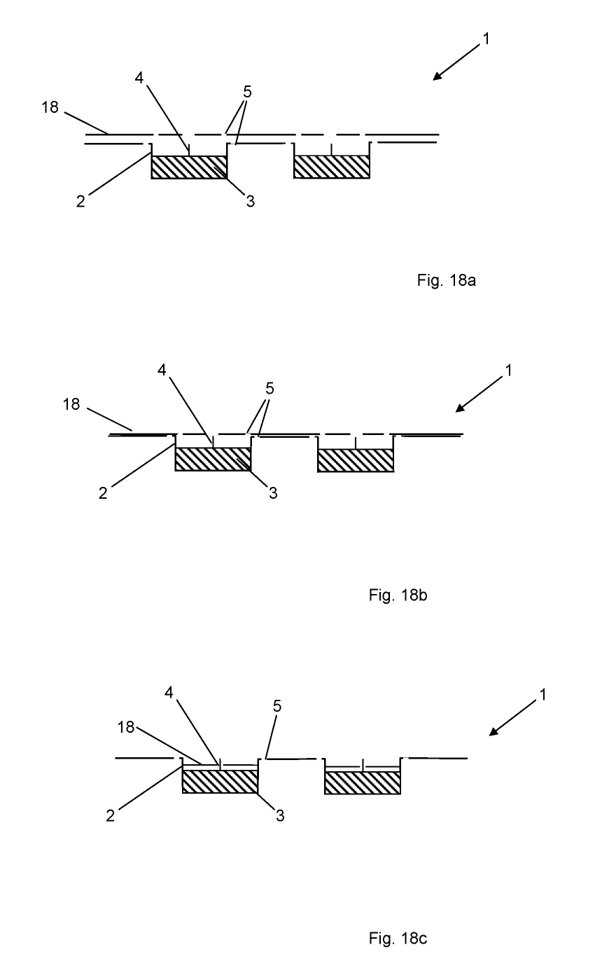

FIGS. 18a to 18c show candle magazines with inlay means.

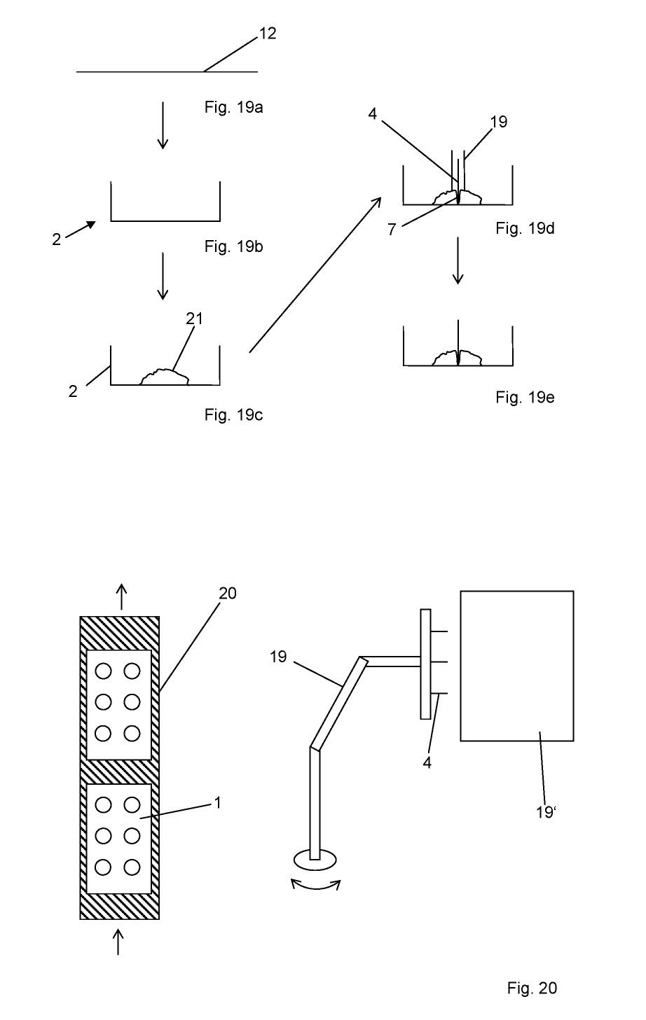

FIGS. 19a to 19e show an embodiment of the method for producing a candle magazine.

FIG. 20 shows an exemplary embodiment of the preparation station.

FIG. 1 shows the candle 14 according to the invention which is composed of a combustible material 3, for example a wax, a wax-like material or a technical wax mixture, in which a wick is provided. According to the invention, the combustible material 3 and the wick 4 are provided in a deep-drawn cup-like structure 2. The cup-like structure 2 is preferably manufactured from a material which is non-combustible and/or of low flammability, in this case from a plastic. It is particularly preferable for said plastic to be compostable, such that no unnecessary residues remain after the candle 14 has been burned.

FIG. 2 shows the candle magazine 1 according to the invention. Said candle magazine is in this case manufactured from a plastics foil into which a multiplicity of cup-like structures 2 have been formed, in particular simultaneously, by deep drawing. In each of said cup-like structures 2 there is provided a candle 14 composed of a combustible material 3 and a wick 4. Each cup-like structure 2 may be closed off by means of a cover foil 6 which is connected, in particular by sealing, to the candle magazine 1. Furthermore, a predetermined breaking point may be provided in each case between two cup-like structures 2, thus enabling a user to separate off the cup-like structures 2 with the candles 14 situated therein, such that in each case one candle 14 as per FIG. 1 is obtained. Here, the predetermined breaking points 5 are provided in the form of a grid, such that the separated-off candles 14 have a protruding portion of material web 12 of substantially square shape. There is thus no material waste after the candles 14 have been separated off, for example in a cutting station 13. Predetermined breaking points 5 of said type are furthermore particularly suitable for candles which have a substantially square cross section. Conversely, this means that the predetermined breaking points 5 preferably have substantially the same cross section as the cup-like structures 2, but with larger dimensions, for example a larger diameter, than the cup-like structures 2. The candles 14 situated in the magazine 1 may be used together with the cup-like structure 2, that is to say the candle 14 burns in the cup-like structure 2, thus preventing run-off of the combustible material 3 which liquefies as the candle 14 is burned. Alternatively, however, it is also conceivable for the candles 14 to be removed from the magazine 1 or the cup-like structure 2 before being burned. This form of use is expedient in particular in the case of so-called floating candles, refill packs or refill candles. The user then preferably presses the candle 14 out of the cup-like structure 2, preferably overcoming a corresponding positive locking and/or non-positive locking action.

FIG. 3 shows a first embodiment of the cup-like structure 2. Said cup-like structure has a side wall 2.1, preferably a side wall which is inclined with respect to the vertical, wherein the cross section of the cup-like structure 2 preferably tapers toward a base region 2.3. Furthermore, the cup-like structure 2 has a base region 2.3 which, in the present case, is inclined relative to the horizontal in the direction of the center of the cup-like structure 2, such that the liquefied combustible material 3 flows in the direction of the wick 4. It is preferable for a recess or protuberance, in this case a recess 2.4, to be provided on the base region 2.3, in which recess the wick 4 and/or a wick holder 7 can be arranged. The wick 4 and/or the wick holder 7 are preferably connected to the base region 2.3, in particular to the recess 2.4, in positively locking, non-positively locking and/or cohesive fashion. The recess and/or protuberance 2.4 serves to prevent the wick 4 from departing from its centered position during the filling with the combustible material 3 and/or as the candle 14 is burned. Furthermore, the base region 2.3 and/or the side wall 2.1 are preferably provided such that the base region 2.3 in which the wick 4 and/or the wick holder 7 is situated is spaced apart from the rest surface 2.2. It is ensured in this way that the rest surface 2.2 on which the candle 14 stands is not damaged as the candle 14 is burned. In the present case, this is achieved by virtue of the side wall 2.1 being deep-drawn to a greater extent than the base region 2.3, 2.4. Alternatively or in addition, however, the base region 2.3, 2.4 may also have protuberances with which the cup-like structure 2 stands on the rest surface 2.2 and which generate a spacing between the base region 2.3, 2.4, in which the wick 4 or the wick holder 7 is situated, and the rest surface 2.2. In the present case, opposite the base region 2.3, the side wall 2.1 has an edge 2.5, in this case an encircling edge, which may serve as a sealing surface for a cover foil 6 that may be provided. Furthermore, however, said edge 2.5 of the cup-like structure 2 also provides additional stability. In particular, it is preferably possible for the side wall 2.1 to have additional recesses and/or protuberances, in particular in order to increase the stability thereof.

FIG. 4 shows a further embodiment of the cup-like structure 2. Reference may be made substantially to the statements made regarding FIG. 3. In the present case, there is additionally provided in the side wall 2.1 a positive locking and/or non-positive locking means 2.6, in this case an undercut, which interacts in positively locking and/or non-positively locking fashion with the combustible material 3 of the candle 14. Said positive locking and/or non-positive locking action serves to prevent the combustible material 3 and the wick 4, that is to say the candle 14, from inadvertently becoming detached from the cup-like structure 2. The positive locking and/or non-positive locking action is achieved in particular by virtue of liquid combustible material 3 being introduced into the cup-like structure 2 and solidifying there. The positive locking and/or non-positive locking action is generated during the solidification process. Said positive locking and/or non-positive locking means 2.6 is preferable in particular if the candle 14 is to be removed from the candle magazine 1 or the cup-like structure 2 before being burned. For this purpose, it is for example the case that a pressure is exerted on the base region, which pressure pushes the candle 14 out of the cup-like structure 2. Here, the positive locking and/or non-positive locking action between the candle 14 and the cup-like structure 2 is eliminated, preferably with a snapping action, and the candle 14 can be used for example as a floating candle. This embodiment is preferable in particular if the candle magazine 1 is used merely as a transportation and/or storage container for the candle 14.

FIG. 5 shows details of the recess and/or protuberance 2.4 for the wick 4. It can be clearly seen that the side walls 2.4.1 of the recess are provided with an undercut such that a positively locking and/or non-positively locking connection is produced between the wick 4 or wick holder 7 and the base region of the cup-like structure 2. Said recess, or a recess of any other form, may for example be produced by virtue of the wick holder 7 being pressed into the plastics foil, for example by means of a punch, during the deep drawing of the cup-like structure 2, with the desired deep-drawn form being produced in the process. When the punch is removed, the wick 4 and/or the wick holder 7 then remains in the thus completed packaging cup-like structure, and is preferably connected to the latter in positively locking and/or non-positively locking fashion.

A person skilled in the art understands that it is also possible in this way for a cohesive action to be generated between the wick 4 or wick holder 7 and the base region 2.3, 2.4 of the cup-like structure 2, for example by means of (ultrasound) sealing or adhesive bonding using an adhesive 21, in particular a melt adhesive, a so-called hot melt adhesive.

FIG. 6 shows the candle magazine 1 which, in the present case, is provided in a packaging, in particular a plastics packaging 8, in particular in a tubular-bag-type packaging. In addition to said packaging, the magazine 1 may also have a cover foil 6. This preferred embodiment of the present invention is desirable in particular if scented candles of different scents are situated in the candle magazine 1. The cover foil 6 prevents the scents of the candles from assimilating.

FIG. 7 shows the deep-drawing apparatus 9 according to the invention by means of which the candle magazine 1 according to the invention or the candle 14 according to the invention can be produced. In the case of this deep-drawing apparatus 9, a material web 12, in this case a foil web 12, moves along the deep-drawing apparatus 9, in this case from right to left. Said transportation is preferably continuous though may also take place in intermittent, that is to say cyclic fashion. The cup-like structure 2 is formed into said material web 12 by deep drawing in a forming station 10. It is preferable for a multiplicity of cup-like structures 2 to be situated adjacent to one another, in particular in the form of a matrix, such that multiple cup-like structures 2 are deep-drawn simultaneously. The deep drawing is preferably performed by virtue of the material web 12 initially being heated, being pre-shaped or pre-drawn if appropriate, and then being formed into a die by means of negative pressure and/or by means of a punch. A wick 4 is fastened in the cup-like structure 2 or to the foil web 12 before, during or after the deep-drawing process. During the deep-drawing process, it is possible for predetermined regions of the material web 12 to be cooled and/or to be fixed to the punch by way of a vacuum. In this way, it is possible for structures, for example recesses, for the fastening of the wick 4 to be produced in a simple manner and in one process step with the cup-like structure 2, and for the material thickness of the cup-like structure 2 to be locally set in an exact manner. A filling station 11 is provided downstream of the forming station 10 and after the point at which the wick 4 is inserted. In the filling station 11, the cup-like structure 2 is filled with a liquid or pasty combustible material 3, which subsequently hardens in the cup-like structure 2. It is however alternatively also possible for an already complete candle 14 to be placed in the cup-like structure 2. This is referred to by a person skilled in the art as a loading station 11.

A person skilled in the art understands that it is also possible for already prefabricated magazines 1 to be delivered to the apparatus. In this case, the forming station 10 may be omitted, and is preferably replaced by an unstacking means.

In a preferred embodiment, the candle magazine 1 is then closed off by means of a cover foil 6 which is fastened, preferably by means of cohesive connection, in particular by means of sealing, to the foil web 12 from which the cup-like structures 2 are manufactured. The candle magazines 1 or the candles 14 are subsequently separated by means of a transverse and/or longitudinal cut in a cutting station 13, and may then optionally also be provided with an additional packaging, for example in a so-called tubular bag machine.

FIGS. 8a, 8b and 9a, 9b show exemplary embodiments of the cup-like structure 2 and of the wick holder 7. Here, FIGS. 8a and 9a show schematic sectional drawings, and FIGS. 8b and 9b show plan views. Reference is generally made to the statements made with regard to FIGS. 3 and 4. Here, it is the case in particular that FIGS. 8a and 9a show the situation before the wick 4 and the wick holder 7 are connected to the cup-like structure 2.

The cup-like structure 2 as per the embodiment illustrated in FIG. 8a has, in the base region 2.3, an opening into which the wick holder 7 is inserted. In this case, the wick 4 is already connected to the wick holder 7, though it is alternatively also possible for the wick 4 to be inserted into the wick holder 7 in positively locking, non-positively locking and/or cohesive fashion only after the wick holder 7 has been connected to the cup-like structure 2.

The wick holder 7 is preferably inserted into the opening of the cup-like structure 2 from above or below. The wick holder 7 is subsequently connected to the cup-like structure 2 for example by welding, pressing and/or crimping, in particular when the base region of the wick holder 7 is arranged flush with the base region 2.3. For this purpose, it is preferable for the wick holder 7 and the cup-like structure 2 to be composed of the same material, in this case plastic, for example. It is alternatively also possible for the wick holder 7 and/or the wick 4 to be connected to the cup-like structure 2 merely in non-positively locking and/or positively locking fashion, in particular by pressing. In this case, the opening of the cup-like structure 2 preferably has a slightly smaller cross section than the wick holder 7. It is also for example conceivable that, after the wick holder 7 and/or the wick 4 has been arranged in the opening, the punch of the deep-drawing apparatus 9 upsets the material in the region of the opening such that a positive locking and/or non-positive locking action is generated between the material in the region of the opening and the wick holder 7 and/or the wick 4.

In particular, the cup-like structure 2 as per the embodiment illustrated here has substantially vertical wall elements in the region of the opening, by means of which wall elements the connection is established between the cup-like structure 2 and wick holder 7. Alternatively, the wall elements are inclined, wherein the resulting weir-like structure serves in particular to predefine a preferential direction for the insertion of the wick 4 and/or of the wick holder 7.

FIG. 8b shows a plan view in which the cup-like structure 2 with the central opening can be clearly seen.

In the embodiment illustrated in FIG. 9a, the cup-like structure 2 has recesses or protuberances. In an edge region of the cup-like structure 2, a recess or protuberance of said type is provided in this case as a groove-like rest surface 2.2, and in the central region of the cup-like structure 2, a recess or protuberance 2.4 serves as a receptacle for the wick holder 7 and/or the wick 4. It is also the case here that the wick 4 is preferably inserted into the wick holder 7 before the connection to the cup-like structure 2 is established. Alternatively, the central recess or protuberance 2.4 is filled with a liquid or pasty material, the wick 4 is inserted into said material, and the material is caused to solidify, such that the recess or protuberance 2.4 serves as a mold for the wick holder 7.

In the embodiment illustrated here, however, the wick holder 7 is pressed into the recess or protuberance 2.4 and is preferably subsequently welded to or sealed with the cup-like structure 2.

At its upper edge, the wick holder 7 has, in this case, a flange-like edge region which serves as a combustion stopper. When the wick 4 has burned down as far as said edge region, the flame is extinguished, such that melting and/or excessive heating of the base region 2.3 of the cup-like structure 2 is prevented. For this purpose, the wick holder may for example additionally or alternatively have a flame-extinguishing coating.

FIG. 9b shows a plan view of the cup-like structure 2 according to the invention. In particular, said figure shows the recess or protuberance 2.4 in the center. The cup-like structures 2 illustrated in FIGS. 8 and 9 are of circular form. A person skilled in the art however understands that any other desired shape, for example square, triangular, elliptical and/or polygonal, is also possible.

FIG. 10 shows an embodiment of the wick 4 and of the wick holder 7 before the connection to the cup-like structure 2 or to the material web 12 is established. Here, the wick 4 is provided in the form of an endless band on which wick holders 7 are provided at regular intervals. Said wick holders are for example formed onto the wick 4. The wick 4 thus resembles a string of pearls. For stabilization and ease of handling, the wick 4 is for example provided with a coating composed of a combustible material, preferably hard wax.

A wick supply means 19, 19′ is then for example configured such that the endless band is guided through the opening of a cup-like structure 2 as per the embodiment described in conjunction with FIGS. 8a and 8b, the wick 4 and/or wick holder 7 is connected to the cup-like structure 2 in positively locking, non-positively locking and/or cohesive fashion, in particular by pressing, crimping, welding and/or sealing, and the wick 4 is cut to length.

FIG. 11 illustrates an embodiment of the preparation station 16. A transportation means, in this case a rotary disk 164, which is driven in rotation about a vertical axis A arranged in its center, has a multiplicity of forming means 162, in this case recesses. A dosing unit 163 fills a forming means 162 with a material from which the wick holder 7 is produced. Here, the material is for example in liquid or at least partially flowable, for example pasty, form. A wick 4 is subsequently inserted into the material or into the forming means 162 and the material is caused to harden.

Here, the material may harden of its own accord, though the hardening may also be assisted, for example by virtue of the forming means 162 being cooled in the case of a wax or wax-like material. Alternatively or in addition, the hardening may be externally induced. For example, a suitable plastic may for example be hardened by being subjected to ultraviolet radiation.

A holding apparatus 161 grips the wick 4 and/or the wick holder 7 formed thereon, withdraws it from the forming means 162, and conveys it to the deep-drawing apparatus 9.

Here, the rotary disk 164 is moved in continuous or stepped fashion. It is clear to a person skilled in the art that the preparation station may also be provided such that multiple dosing units 163 simultaneously fill multiple forming means 162. In this case, it is likewise the case that multiple holding apparatuses 161 are provided or that the holding apparatus 161 is designed such that it simultaneously withdraws multiple wicks 4 and/or wick holders 7.

Alternatively, the transportation means is a linear guide such as, for example, an endless conveyor belt. This is advantageous if a large number of wick holders 7 are to be formed onto wicks 4 simultaneously.

FIG. 12 illustrates an embodiment of the positioning means 15. The positioning means 15 comprises two plates 151 which are arranged parallel to and spaced apart from one another. The plates 151 are connected by a pipe element 152 which is guided in each case through openings in the plates 151 and is oriented perpendicular to the plates. Here, the pipe element 152 is dimensioned such that exactly one wick 4 with wick holder 7 can be guided in the interior of the pipe element 152, that is to say, for example, the internal diameter of the pipe element 152 corresponds to a largest diameter of the wick holder 7.

The plates 151 and the pipe element 152 are coupled, in this case inter alia by means of a spiral spring 153 which is arranged between the plates 151 and around the pipe element 152. The coupling may additionally or alternatively be realized by way of positive locking and/or non-positive locking means, for example by means of a slotted guide, or by means of a cohesive connection. The spring means advantageously makes an automatic restoring action possible.

The plates 151 are in this case movable toward one another and away from one another independently of one another. It is thus possible here for the plates 151 to assume in each case a first position and a second position.

The pipe element 152 has, on one end, a closing means 154 that can be adjusted at least between an open position and a closed position. The illustration here shows the open position. In this position, the wick 4 with wick holder 7 falls out of the pipe element 152 under the force of gravity. In the closed position, the wick 4 and wick holder 7 are held in the pipe element 152 such that they cannot fall out.

In order that the wick 4 and wick holder 7 are reproducibly always positioned in the center of a cup-like structure 2, the positioning means 15 has a centring means, in this case a centring disk 155, which is arranged, for example in positively locking, non-positively locking and/or cohesive fashion, on the pipe element 152 in the region of the closing means 154. The mode of operation of the positioning means 15 will be explained in detail on the basis of FIGS. 14a to 14c.

FIG. 13 shows a perspective view of the positioning means 15. In the embodiment illustrated here, multiple pipe elements 152 are provided between the plates 151, such that a multiplicity of cup-like structures 2 can be supplied with wicks simultaneously. The movement of the plates 151 is transmitted synchronously to all of the pipe elements 152 by means of the spiral springs 153.

FIGS. 14a, 14b, 14c show the positioning means 15 in different positions. The function of the positioning means 15 will in this case be described, for simplicity, for only one pipe element 152, wherein a person skilled in the art however understands that the statements also apply to a positioning means 15 as illustrated in FIG. 13.

The positioning means 15 is lowered into a cup-like structure 2. Here, a positive locking and/or non-positive locking action is generated between the side wall 2.1 of the cup-like structure 2 and the centring disk 2, such that the pipe element 152 is centerd with respect to the cup-like structure 2. As illustrated in FIG. 14a, the upper plate 151 is now lowered into the second position, as indicated by the double arrow, such that by means of corresponding coupling, the closing means 154 is moved into the open position. A wick 4 with wick holder 7 provided in the pipe element 152 falls out into the cup-like structure 2, for example into a recess or protuberance 2.4.

The upper plate 151 is then moved back into the first position, as illustrated in FIG. 14b. Owing to the coupling, the closing means 154 is moved back into the closed position. It is thus no longer possible for a wick 4 or wick holder 7 to fall out, thereby ensuring that only one wick 4 with wick holder 7 is provided in each cup-like structure 2.

Finally, the second, lower plate 151 is moved into the second position, as illustrated in FIG. 14c. As a result, the pipe element 152 is likewise moved in the direction of the cup-like structure 2, whereupon the closing means 154 exerts a force on the wick 4 and/or on the wick holder 7, whereby the wick 4 and/or the wick holder 7 is connected to the cup-like structure 2.

In the embodiment illustrated, the wick 4 and/or wick holder 7 are pressed into a recess or protuberance 2.4 such that a positive locking and/or non-positive locking action is generated. Alternatively or in addition, the side wall 2.4.1 of the recess or protuberance is upset. The positioning means 15 can then be moved out of the cup-like structure 2, the cup-like structure 2 provided with a wick can be removed, and a cup-like structure 2 to be provided with a wick can be moved under the positioning means, whereupon the described steps are performed again from the beginning.

A person skilled in the art understands that the upper and lower plates 151 are interchangeable in terms of their functionality. It is clear that the described mechanism is similar to that of a propelling pencil.

FIG. 15 illustrates a candle magazine 1 according to the invention. Here, the candle magazine 1 substantially corresponds to the candle magazine 1 illustrated in FIG. 2. Therefore, the statements relating to said figure are referred to generally here. By contrast to the candle magazine 1 illustrated in FIG. 2, the predetermined breaking points 5 are in this case provided in circular form and concentrically with respect to the likewise circular cup-like structures 2. The candles 14 can be separated off from the candle magazine 1 for example by being pushed out. In this way, although the remaining material web 12 forms waste, it is realized in exchange that the separated-off candles 14 already substantially correspond to their desired shape for use. If the candle magazine 1 comprises a cover foil 6, the predetermined breaking points 5 may alternatively or additionally also be provided such that an opening region in the form of a tab is provided in order that the cover foil 6 can be easily pulled off from the separated-off candles 14. It is preferable for the predetermined breaking points 5 to border a region which has the same shape as, and is arranged concentrically with respect to, the cup-like structure 2 arranged therein.

FIGS. 16a to 16d illustrate different embodiments of the cup-like structure 2. Here, the individual figures illustrate differing features in each case in an exemplary manner. A person skilled in the art will recognize that the individual features may also be exchanged for one another, that is to say a cup-like structure 2 may for example have an edge 2.5 corresponding to FIG. 16c, a base region 2.3 corresponding to the illustration in FIG. 16a and a stabilization means 17 corresponding to the illustration in FIG. 16d. Here, the individual figures show merely details.

FIG. 16a illustrates a cup-like structure 2 with a substantially horizontally oriented edge 2.5, onto which there is sealed a cover foil 6 which covers the candle 14, for example in aroma-tight fashion. The side wall 2.1 is inclined relative to the vertical, and the base region 2.3 is inclined relative to the horizontal. In this case, the angle of the incline of the base region 2.3 is smaller than the angle of the incline of the side wall 2.1. The edge 2.5 has, in this case, a radial extent of approximately 2 mm.

FIG. 16b illustrates a cup-like structure 2 with a substantially vertical side wall 2.1 and horizontal base region 2.3. In the case of such an arrangement, there is consequently a right angle between the side wall 2.1 and the base region 2.3. Furthermore, the edge 2.5 of the cup-like structure 2 is in this case inclined relative to the horizontal and relative to the side wall 2.1. Sealing of a cover foil 6 is made simpler in this way.

Since the cup-like structure 2 is produced from a deep-drawn material web 12, the material exhibits a certain thermal restoring or spring-back movement, normally in the range of around 2%. This means that, when a combustible material 3 provided in the cup-like structure 2 burns, the resulting generation of heat leads to a deformation as shown in the lower left-hand region of the illustration. Such material bulging may be disadvantageous, for example if the candles 14 are arranged in a vessel and the material bulge prevents air recirculation, causing an exchange of heat to be prevented and at least a faster burn-off of the candle.

To prevent such a thermal restoring movement, the cup-like structure 2 preferably has a stabilization means 17. The cup-like structures 2 illustrated in FIGS. 16c and 16d each have a stabilization means 17 of said type in the connecting region between side wall 2.1 and base region 2.3. In FIG. 16c, the stabilization means 17 is a double bead. This functions for example as a material reservoir and/or as a mechanical reinforcement. A temperature-induced spring-back movement in this case does not lead to a material bulge in the radial direction beyond the side wall 2.1 as in the illustration of FIG. 16b, but rather for example to a connecting region similar to the illustration in FIG. 16a. In the embodiment as per FIG. 16c, the edge 2.5 of the cup-like structure 2 furthermore has an elevation which facilitates sealing of the cover foil 6.

The cup-like structure 2 as per the embodiment illustrated in FIG. 16d has an inclined edge 2.5 and an inclined side wall 2.1, whereas the base region 2.3 is provided so as to be substantially parallel to the horizontal. Furthermore, the cup-like structure 2 has a stabilization means 17 in the form of a single bead. By contrast to the stabilization means 17 as per the embodiment illustrated in FIG. 16c, the individual sections of the bead are in this case provided so as to be inclined relative to the horizontal and relative to the vertical.

In a preferred embodiment, it is alternatively or additionally provided that the material web 12 is pre-stretched during the deep-drawing process, such that the material thickness of the cup-like structure 2 can be controlled in all regions. For example, by way of the pre-stretching or pre-drawing, it is possible for a thermal spring-back or restoring movement in the connecting region between side wall 2.1 and base region 2.3 to be at least reduced.

FIGS. 17a and 17b show recesses 2.4 for the wick 4 or the wick holder 7. In both cases, the cup-like structure 2 has rest surfaces 2.2 in the form of elevations on the underside of the base region 2.3, for example in the form of feet. These are preferably of substantially hemispherical form. Alternatively or in addition, an encircling concentric bead is provided in the base region as a rest surface 2.2. In FIG. 17a, the elevations form the only rest surfaces 2.2 that make contact with an underlying surface, whereas the elevations in the illustration in FIG. 17b form rest surfaces 2.2 together with the recess 2.4. The local rest surfaces 2.2 have the effect of improving the air recirculation on the underside of a candle 14 standing on an underlying surface.

FIG. 17a illustrates two recesses 2.4; one narrow, deep recess 2.4, into which the wick 4 is inserted, and one wide, shallow recess 2.4, which is filled with adhesive 21, for example a melt adhesive. Firstly, after the deep-drawing process, melt adhesive is introduced into the cup-like structure 2. The wick 4 is inserted before the melt adhesive has fully hardened. By way of the melt adhesive and the narrow, deep recess 2.4, the wick 4 is connected in both cohesive and also positively locking and non-positively locking fashion to the cup-like structure 2.

By contrast, in FIG. 17b, the cup-like structure 2 has only one narrow, deep recess 2.4. Here, either the positively locking and/or non-positively locking connection of the wick 4 to the recess 2.4 is sufficient for adequate stabilization of the wick 4, or said wick is additionally connected to a wick holder 7.

FIGS. 18a to 18c illustrate candle magazines 1 with inlay means 18 in schematic cross sections. FIG. 18a illustrates a candle magazine with cup-like structures 2 in which combustible material 3 and wicks 4 have already been arranged. The candle magazine 1 has, around the cup-like structures 2, predetermined breaking points 5 by way of which the cup-like structures 2 and the candles 14 can be separated off. A sheetlike inlay means 18 has been arranged on the candle magazine 1. Here, for better clarity, the inlay means 18 has been illustrated spaced apart from the candle magazine 1. In reality, however, the inlay means 18 lies on the candle magazine 1. The inlay means 18 is produced for example from a flame-retardant composite foil, and has predetermined breaking points 5 which are arranged such that regions of the inlay means 18 can be separated off, wherein said regions, in terms of their shape, substantially correspond to the inner cross section of the cup-like structures 2, but preferably have a slightly smaller radius than the cup-like structures 2.

The inlay means 18, and preferably each of the regions that can be separated off, are preferably of colored design and/or printed, and have an opening in particular in the region of the wicks 4. Here, the inlay means 18 has a main plane of extent, the dimensions of which correspond substantially to the dimensions of the candle magazine 1. The inlay means 18 is for example laid onto the candle magazine 1 and subsequently enclosed, together with the candle magazine 1, in a tubular-bag-type packaging.

Before use, the tubular-bag-type packaging is removed, and a candle 14 is separated off from the candle magazine 1 by exertion of force, in such a way that a region of the inlay means 18 is also separated off. In this case, the predetermined breaking points 5 of the candle magazine 1 are not provided congruently with the predetermined breaking points 5 of the inlay means 18. As a result, during the separating-off of the candles 14, it is firstly the case that an edge 2.5 is realized, and secondly, the separated-off region of the inlay means 18 is smaller than the inner cross section of the cup-like structure 2, such that, during the burning of the candle 14, the region moves downward, together with the combustible material 3, in the direction of the base region 2.3. The inlay means 18 is preferably fire-retardant in order to eliminate the risk of fire.

FIG. 18b illustrates a further embodiment of the inlay means 18. In this case, the inlay means 18 is cohesively connected to the candle magazine 1, in particular to the cup-like structures 2, for example by being sealed on in the edge regions 2.5 of the cup-like structures 2. Alternatively or in addition, the inlay means 18 is provided, on its underside, with an adhesive, such that it adheres to the candle magazine 1 and/or to the combustible material 3 when it comes into contact therewith. In this way, the inlay means 18 can serve as a replacement for a cover foil 6.

It is however also conceivable for a cover foil 6 to additionally be fastened over the inlay means 18, for example by sealing. In this embodiment, too, the inlay means 18 has regions that can be separated off by way of predetermined breaking points 5.

FIG. 18c shows yet a further embodiment. In this case, the inlay means 18 is arranged in the form of already-separated regions on the combustible material 3 in the cup-like structures 2, and is for example cohesively connected thereto by way of an adhesive. In this case, merely for better clarity, the inlay means 18 is illustrated spaced apart from the combustible material 3.

FIGS. 19a to 19e illustrate an embodiment of the method for producing a candle magazine 1. Here, FIG. 19a firstly schematically shows the material web 12 for the cup-like structure 2 and/or the magazine 1. For simplicity, the figures illustrate just one cup-like structure 2, but a person skilled in the art will understand that the method discussed can likewise be transferred to a magazine 1 having multiple cup-like structures 2.

A cup-like structure 2 is deep-drawn out of said material web 12. The deep-drawn cup-like structure 2 is shown in FIG. 19b. Subsequently, as illustrated in FIG. 19c, an adhesive 21, preferably a hot melt adhesive, is introduced, in particular centrally, into the cup-like structure. Here, the amount of adhesive 21 is selected such that a wick 4 inserted therein is held adequately securely when the adhesive 21 is in the solidified state.

As illustrated in FIG. 19d, a wick 4 is then inserted by way of a wick supply means 19, 19′ into the cup-like structure, in particular into the adhesive 21. The wick 4 is preferably pressed into the adhesive 21, that is to say is inserted into the adhesive 21 with a force greater than an opposing force generated by the adhesive 21. Here, the adhesive 21 has not yet solidified, or at least has not yet fully solidified.

After the solidification of the adhesive 21, a wick holder 7 is thus formed integrally in the cup-like structure 2 as a result of the insertion or pressing-in of the wick 4 into the adhesive 21. This is shown in FIG. 19e.

FIG. 20 illustrates an exemplary embodiment of the wick supply means. Deep-drawn cup-like structures 2 or magazines 1 are supplied by way of a transportation means 20, in this case a conveyor belt in the form of an endless belt. The transportation direction is indicated here by arrows.

A wick supply means 19, 19′ is in this case of two-part form. Firstly, the wick supply means 19, 19′ comprises a wick fitting station 19′, which in this case is illustrated merely schematically in the right-hand region of the figure, by means of which wick fitting station wicks 4 are provided and at which wick fitting station a wick holding apparatus of the wick supply means 19 is equipped. Said wick holding apparatus is in this case provided on a movable robot arm. The wick holding apparatus preferably has at least one vacuum-generating means. The one or more vacuum-generating means is or are formed at wick holders. In this case, the wick-holding apparatus is of substantially plate-like form, wherein the wick-holding apparatus preferably has, in its main plane of extent, substantially the same dimensions as the magazine 1, that is to say said wick-holding apparatus is preferably congruent with the magazine 1 when arranged over the latter.

At the wick fitting station 19′, the wick holders receive wicks 4. A detection means preferably monitors whether a wick 4 is arranged, or correctly position and/or orientated, in all of the wick holders. Erroneous fitting of a magazine 1 with wicks is thus prevented.

Subsequently, the robot arm moves the wick-holding apparatus, preferably such that said wick-holding apparatus is positioned over the magazine 1 and congruently with respect thereto. Then, the wick supply means 19 presses the wicks 4 into the cup-like structures 2, wherein the wick holders are arranged at or in the wick-holding apparatus, and the wick-holding apparatus is moved, such that a wick 4 is inserted centrally, and in particular vertically, into each cup-like structure 2. The wicks 4 may in this case already be equipped with a wick holder 7 in the wick supply means 19, 19′, the wick holders 7 may be provided before the insertion into the cup-like structures 2, or the wick holders may be formed into the cup-like structures 2 during or as a result of the insertion.

The detection means, or a further detection means, preferably monitors for the presence of a wick 4 in each cup-like structure 2, and/or for the correct positioning of the wicks 4. For this purpose, it is for example possible for a camera system to be provided.

Finally, the magazine 1 that has been fitted with wicks is moved to a filling station 11, in which the combustible material 3 is introduced into the cup-like structures 2. This is not illustrated here.

In one possible refinement of the embodiment, the wick supply means 19 comprises multiple robot arms, which each have a wick-holding apparatus. Here, the wick supply means 19, 19′ is preferably configured such that it is always the case that one wick-holding apparatus is equipped with wicks 4 at the wick fitting station 19′ while a further wick-holding apparatus fits wicks to the magazine 1. Thus, a continuous process is made possible, and the process speed is significantly increased.

The wick-holding apparatus is preferably provided as a changeable tool, such that, for the fitting of wicks to different magazine shapes and/or sizes, it is merely necessary for the wick-holding apparatus or apparatuses to be exchanged.

It is also conceivable, for example, for a detection means to monitor the advancing movement of the transportation means 20, and to synchronize this with the cycle speed of the wick supply means 19, 19′.

### LIST OF REFERENCE SIGNS

1 Candle magazine
2 Cup-like structure
2.1 Side wall
2.2 Rest surface
2.3 Base region
2.4 Recess or protuberance for the wick
2.4.1 Side wall of the recess or protuberance
2.5 Edge, encircling edge
2.6 Undercut
3 Combustible material
4 Wick
5 Predetermined breaking point
6 Cover foil
7 Wick holder
8 Packaging
9 Deep-drawing apparatus
10 Forming station
11 Filling station, loading station
12 Material, in particular foil web for the cup-like structure and/or the magazine
13 Cutting station
14 Candle
15 Positioning means
151 Plate
152 Pipe element
153 Spiral spring
154 Closing means
155 Centring disk
16 Preparation station
161 Holding apparatus
162 Forming means
163 Dosing unit
164 Rotary disk
17 Stabilization means
18 Inlay means
19, 19′ Wick supply means
20 Transportation means
21 Adhesive
A Axis of rotation

1. A candle magazine, characterized in that said candle magazine has a multiplicity of deep-drawn cup-like structures in which there is provided in each case one candle composed of a combustible material and of a wick.

2. The candle magazine as claimed in claim 1, characterized in that the wick is directly or indirectly connected to the cup-like structure in positively locking, non-positively locking and/or cohesive fashion.

3. The candle magazine as claimed in claim 1, characterized in that each cup-like structure has a base region in which there is provided a recess and/or protuberance in which the wick and/or a wick holder is fastened.

4. The candle magazine as claimed in claim 3, characterized in that the base region is provided so as to be inclined relative to the horizontal at least in sections.

5. The candle magazine as claimed in claim 1, characterized in that a predetermined breaking point is provided between two cup-like structures.

6. The candle magazine as claimed in claim 1, characterized in that the cup-like structure has a means that connects the combustible material to the cup-like structure in positively locking and/or non-positively locking fashion.

7. A candle having a combustible material and a wick, characterized in that said candle is provided in a deep-drawn cup-like structure.

8. The candle as claimed in claim 7, characterized in that said candle is separated off from a candle magazine according to one of the preceding claims.

9. A method for producing a candle as claimed in claim 7, characterized in that the cup-like structure is deep-drawn from a material web, the wick is provided in the cup-like structure, and the cup-like structure is filled with the combustible material.

10. The method as claimed in claim 9, characterized in that the wick is connected to the cup-like structure before, during or after the deep-drawing and/or before the filling of the cup-like structure with the combustible material.

11. A deep-drawing apparatus, having a forming station which forms the cup-like structures into a material web by means of deep drawing, characterized in that said deep-drawing apparatus has a wick supply means that connects one wick per cup-like structure directly or indirectly to the material web or to the cup-like structure.

12. A deep-drawing apparatus, having a forming station which forms the cup-like structures into a material web by means of deep drawing, characterized in that said deep-drawing apparatus has a loading station which places in each case one complete candle into a cup-like structure.

13. A candle, in particular as claimed in either of claims 7 and 8, having a combustible material, wherein the candle comprises, for a burning duration of 4 h, less than 12 g, of the combustible material.
